(19) United States
(12) Patent Application Publication
(10) Pub. No.: US 2026/0176194 A1
(43) Pub. Date: Jun. 25, 2026

(54) GLASS

(71) Applicant: AGC Inc., Tokyo (JP)

(72) Inventors: Rikiya KADO, Tokyo (JP); Seiki OHARA, Tokyo (JP); Yuha KOBAYASHI, Tokyo (JP); Mamoru ISOBE, Tokyo (JP)

(73) Assignee: AGC Inc., Tokyo (JP)

(21) Appl. No.: 19/447,998

(22) Filed: Jan. 13, 2026

Related U.S. Application Data
(63) Continuation of application No. PCT/JP2024/024676, filed on Jul. 9, 2024.

(30) Foreign Application Priority Data
Jul. 18, 2023 (JP) 2023-117090

(51) Int. Cl. C03C 21/00; C03C 3/085; C03C 3/087; C03C 3/093; C03C 3/095; C03C 3/21

(52) U.S. Cl. CPC C03C 21/002; C03C 3/085; C03C 3/087; C03C 3/093; C03C 3/095; C03C 3/21

(57) ABSTRACT

A decrease in light transmittance is suppressed even after exposure to an acid while suppressing deflection. In the glass (10), a Young's modulus is 90 GPa or more, and an arithmetic average roughness Ra (nm) of a surface defined in JIS B 0601:2001 is equal to or less than a recycling parameter value shown in Formula (1).

### CROSS-REFERENCE TO RELATED APPLICATION(S)

This application is a continuation of International Application No. PCT/JP2024/024676, filed on Jul. 9, 2024 which claims the benefit of priority of the prior Japanese Patent Application No. 2023-117090, filed on Jul. 18, 2023, the entire contents of which are incorporated herein by reference.

### BACKGROUND OF THE INVENTION

### 1. Field of the Invention

The present invention relates to a glass.

### 2. Description of the Related Art

For example, as disclosed in JP 2021-20840 A, a glass having a high Young's modulus in order to suppress deflection is known.

However, a glass having a high Young's modulus tends to have low acid resistance, and a surface thereof may be roughened after being exposed to an acid by acid cleaning or the like, which may lower the light transmittance in some cases.

An object of the present invention is to provide a glass capable of suppressing a decrease in light transmittance even after being exposed to an acid while suppressing deflection.

### SUMMARY OF THE INVENTION

It is an object of the present invention to at least partially solve the problems in the conventional technology.

In the glass of the present disclosure, Young's modulus is 90 GPa or more, and an arithmetic average roughness Ra (nm) of a surface, defined in JIS B 0601:2001 is equal to or less than a recycling parameter value A shown in Formula (1):

$$\begin{matrix}A = ( 13 \times [ {SiO}_{2} ] - 3 \times [ {Al}_{2} {O}_{3} ] - [ {B}_{2} {O}_{3} ] - 7 \times \\ [ MgO ] - 4 \times [ CaO ] - 0.5 \times [ SrO ] - [ BaO ] - [ {R}_{2} O ] ) / 1000\end{matrix} , \qquad ( 1 )$$

[SiO₂] is a content of SiO₂ in terms of mol % on an oxide basis, [Al₂O₃] is a content of Al₂O₃ in terms of molo on an oxide basis, [B₂O₃] is a content of B₂O₃ in terms of molo on an oxide basis, [MgO] is a content of MgO in terms of mol % on an oxide basis, [Cao] is a content of Cao in terms of mol % on an oxide basis, [Sro] is a content of Sro in terms of mol % on an oxide basis, [Bao] is a content of BaO in terms of mol % on an oxide basis, and [R₂O] is a total value of contents of monovalent element oxides contained in the glass in terms of mol % on an oxide basis.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of a glass according to the present embodiment; and

FIG. 2 is a schematic view for illustrating a deflection evaluation.

### DETAILED DESCRIPTION OF THE PREFERRED EMBODIMENTS

Hereinafter, preferred embodiments of the present invention will be described in detail with reference to the accompanying drawings. Note that the present invention is not limited by the embodiments, and in a case where there are a plurality of embodiments, the present invention includes a combination of the embodiments. Also, the numerical value includes a range of rounding.

### Glass

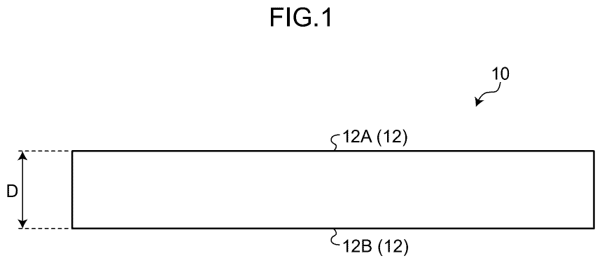

FIG. 1 is a schematic view of a glass according to the present embodiment. As illustrated in FIG. 1, a glass 10 according to the present embodiment is used as a glass substrate for manufacturing a semiconductor package, and more specifically, is a supporting glass substrate for manufacturing FOWLP or the like. However, the glass 10, in applications thereof, is not limited to the manufacture of FOWLP or the like, may be used in any application, may be a glass substrate used for supporting a member, and may be used for an application other than the support of a member. Note that FOWLP or the like includes a fan out wafer level package (FOWLP) and a fan out panel level package (FOPLP).

### Young's Modulus of Glass

The Young's modulus of the glass 10 is 90 GPa or more, preferably 95 GPa or more, and more preferably 100 GPa or more. The Young's modulus of the glass 10 is preferably 90 GPa or more and 150 GPa or less, more preferably 95 GPa or more and 130 GPa or less, and still more preferably 100 GPa or more and 120 GPa or less. When the Young's modulus falls within this range, deflection can be suppressed, and cutting, grinding, and polishing processing can be easily performed. The Young's modulus of the glass 10 was measured by an ultrasonic pulse method defined in JIS R 1602:1995 “Testing methods for elastic modulus of fine ceramics”. The bulk density of a sample is measured by the Archimedes method, the longitudinal wave velocity and the transverse wave velocity are measured using an ultrasonic thickness gauge 38DL PLUS manufactured by OLYMPUS, and the value of Young's modulus can be determined.

Recycling parameter value A recycling parameter value A of the glass 10 is defined as a value expressed by the following Formula (1). The recycling parameter value A is a parameter calculated based on the composition of the glass 10.

$$\begin{matrix}A = ( 13 \times [ {SiO}_{2} ] - 3 \times [ {Al}_{2} {O}_{3} ] - [ {B}_{2} {O}_{3} ] - 7 \times \\ [ MgO ] - 4 \times [ CaO ] - 0.5 \times [ SrO ] - [ BaO ] - [ {R}_{2} O ] ) / 1000\end{matrix} , \qquad ( 1 )$$

Here, in Formula (1), [SiO₂] is a content of SiO₂ contained in the glass 10 in terms of mol % on an oxide basis, [Al₂O₃] is a content of Al₂O₃ contained in the glass 10 in terms of mol % on an oxide basis, [B₂O₃] is a content of B₂O₃ contained in the glass 10 in terms of mol % on an oxide basis, [MgO] is a content of MgO contained in the glass 10 in terms of mol % on an oxide basis, [Cao] is a content of Cao contained in the glass 10 in terms of mol % on an oxide basis, [Sro] is a content of Sro contained in the glass 10 in terms of mol % on an oxide basis, and [Bao] is a content of BaO contained in the glass 10 in terms of mol % on an oxide basis.

In addition, [R₂O] is a total value of contents of monovalent element oxides contained in the glass 10 in terms of molo on an oxide basis. That is, for example, in a case where the glass 10 contains Li₂O, Na₂O, and K₂O on an oxide basis, [R₂O] can be said to be a total value ([Li₂O]+ [Na₂O]+ [K₂O]) of the content (mol %) of Li₂O contained in the glass 10, the content (mol %) of Na₂O contained in the glass 10, and the content (mol %) of K₂O contained in the glass 10.

In addition, the glass 10 may not contain all the oxides listed in Formula (1). In Formula (1), the content of the oxide not contained in the glass 10 is treated as zero.

### Surface Roughness of Glass

An arithmetic average roughness Ra (nm) of the surface 12 of the glass 10 is equal to or less than the recycling parameter value A described above. The surface 12 refers to a principal surface of the glass 10. When a principal surface on one side of the glass 10 is a surface 12A and a principal surface on an opposite side of the surface 12A is a surface 12B, the surface 12 refers to both of the surfaces 12A and 12B, but is not limited thereto, and may refer to at least one of the surfaces 12A and 12B. That is, in the glass 10, the arithmetic average roughness Ra of both the surface 12A and the surface 12B is preferably equal to or less than the recycling parameter value A, but the arithmetic average roughness Ra of at least one of the surface 12A or the surface 12B may be equal to or less than the recycling parameter value A.

As a result of intensive studies, the present inventor has found that by setting the arithmetic average roughness Ra of the surface 12 to a value equal to or less than the recycling parameter value A, a decrease in light transmittance (that is, deterioration in haze value) can be suppressed even in a case where the surface 12 is roughened by exposing the glass 10 to an acid. Specifically, in a case where the arithmetic average roughness Ra of the surface 12 is greater than the recycling parameter value A, the surface 12 having originally large irregularities is roughened by an acid, the degree of irregularities further increases, and light is less likely to be transmitted through the surface. On the other hand, by setting the arithmetic average roughness Ra of the surface 12 to be equal to or less than the recycling parameter value A, even if the surface 12 is roughened by an acid, the degree of irregularities does not increase to such an extent, and it is possible to suppress the difficulty of light transmission. Note that the light herein may refer to light of any wavelength, and for example, may refer to infrared rays or ultraviolet rays, or may refer to visible light.

The arithmetic average roughness Ra is measured in accordance with the specifications of JIS B 0601:2001 “Geometric Characteristic Specification (GPS) of Product”.

A ratio (Ra/A) of the arithmetic average roughness Ra (nm) of the surface 12 to the recycling parameter value A is preferably 0.75 or less, more preferably 0.01 or more and 0.72 or less, still more preferably 0.1 or more and 0.65 or less, and still further preferably 0.55 or less. When the ratio of the arithmetic average roughness Ra to the recycling parameter value A falls within this range, the difficulty of light transmission can be suitably suppressed.

The arithmetic average roughness Ra of the surface 12 described above refers to the arithmetic average roughness of the surface 12 in a state before the glass 10 is exposed to an acid. The state before the glass 10 is exposed to an acid refers to a state in which the arithmetic average roughness Ra of the surface 12 has been confirmed to be within the above range, and in which the glass has not been exposed to an acid. Therefore, for example, the arithmetic average roughness of the surface 12 may be returned to the range of the arithmetic average roughness Ra by polishing the surface 12 after exposing the glass 10 to an acid. This state can also be referred to as a state before the glass 10 is exposed to an acid.

### Composition of Glass

Next, a preferred composition of the glass 10 will be described. Here, the glass 10 may have any composition in which the Young's modulus and the arithmetic average roughness Ra of the surface 12 satisfy the above ranges.

In the glass 10, a value E represented by the following Formula (2) is preferably 0.8 or more, more preferably 0.85 or more, still more preferably 0.90 or more, and still further preferably 0.95 or more. When the value E falls within this range, the Young's modulus can be increased to appropriately suppress the deflection.

$$\begin{matrix}E = ( 122 - 0.53 \times [ {SiO}_{2} ] + 0.35 \times [ {Al}_{2} {O}_{3} ] ) - 1.15 \times \\ [ {B}_{2} {O}_{3} ] + 0.2 \times [ MgO ] - 0.15 \times [ CaO ] - 0.01 \times [ SrO ] - 1.25 \\ \times [ BaO ] ) / 100\end{matrix} \qquad ( 2 )$$

### SiO₂

It is preferable that the glass 10 contain SiOz (the content of SiO₂ be higher than 0 mol %). SiO₂ is a component that lowers a linear thermal expansion coefficient and is a component for controlling the magnitude of the Young's modulus. In the glass 10, the content of SiO₂ is preferably 35% or more and 60% or less, more preferably 40% or more and 55% or less, still more preferably 45% or more and 53% or less, and still further preferably 48% or more and 51% or less in terms of mol % on an oxide basis.

When the content of SiO₂ falls within this range, the Young's modulus can be increased to suppress deflection. Furthermore, by setting the content of SiO₂ within such a range, the Young's modulus can be increased, but the acid resistance deteriorates. On the other hand, in the present embodiment, by setting the arithmetic average roughness Ra of the surface 12 to be less than the recycling parameter value A calculated based on the content of SiO₂, it is possible to suppress a decrease in transmittance due to an acid while suppressing deflection with a high Young's modulus.

Al₂O₃

Al₂O₃ has effects of increasing the Young's modulus to suppress deflection and of suppressing phase separation of a glass. When the content of Al₂O₃ is 68 or more, these effects can be easily exhibited. In addition, by setting the content of Al₂O₃ to 30% or less, it is possible to suppress an increase in the liquid phase temperature. Therefore, in the glass 10, the content of Al₂O₃ is preferably 6% or more and 30% or less, more preferably 8% or more and 25% or less, still more preferably 9% or more and 20% or less, still further preferably 118 or more and 15% or less, and even further preferably 12% or more and 14% or less in terms of mol % on an oxide basis. When the content of Al₂O₃ falls within this range, it is possible to suppress a decrease in transmittance due to an acid while suppressing deflection with a high Young's modulus.

B₂O₃

B₂O₃ has effects of suppressing devitrification due to crystallization of a glass to facilitate manufacturing and of controlling Young's modulus. On the other hand, when the content is too large, the acid resistance deteriorates. Therefore, the glass 10 may not contain B₂O₃ (the content of B₂O₃ is 0 mol %), and may contain B₂O₃. In the glass 10, the content of B₂O₃ is preferably 0% or more and 8% or less, more preferably 1% or more and 6% or less, and still more preferably 3% or more and 5% or less in terms of mol % on an oxide basis. When the content of B₂O₃ falls within this range, it is possible to suppress a decrease in transmittance due to an acid while suppressing deflection with a high Young's modulus.

### MgO

Since MgO increases the Young's modulus without increasing the density, the deflection can be suppressed by increasing the specific elastic modulus. In addition, there is also an effect of reducing the linear thermal expansion coefficient. Therefore, the glass 10 preferably contains MgO. In the glass 10, the content of MgO is preferably 8% or more and 44% or less, more preferably 9% or more and 44% or less, still more preferably 9.5% or more and 40% or less, still further preferably 10% or more and 36% or less, even further preferably 12% or more and 32% or less, even further preferably 15% or more and 28% or less, even further preferably 17% or more and 24% or less, and even further preferably 19% or more and 21% or less in terms of mol % on an oxide basis. When the content of MgO falls within this range, it is possible to suppress a decrease in transmittance due to an acid while suppressing deflection with a high Young's modulus.

### CaO

Cao has a characteristic of increasing the specific elastic modulus second to MgO among oxides of Group 2 elements. Therefore, the glass 10 may not contain Cao or may contain Cao. In the glass 10, the content of Cao is preferably 0% or more and 25% or less, more preferably 3% or more and 23% or less, still more preferably 5% or more and 21% or less, still further preferably 7% or more and 19% or less, even further preferably 9% or more and 17% or less, even further preferably 11% or more and 16% or less, and even further preferably 14% or more and 15% or less in terms of mol % on an oxide basis. When the content of Cao falls within this range, it is possible to suppress a decrease in transmittance due to an acid while suppressing deflection with a high Young's modulus.

### Sro

Sro has an effect of increasing the linear thermal expansion coefficient in the oxides of Group 2 elements. The glass 10 may not contain Sro or may contain Sro. In the glass 10, the content of Sro is preferably 0.1% or more and 11% or less, more preferably 1% or more and 9% or less, and still more preferably 3% or more and 5% or less in terms of molo on an oxide basis. When the content of Sro falls within this range, it is possible to suppress a decrease in transmittance due to an acid while suppressing deflection with a high Young's modulus.

### Bao

Bao has a greater effect of increasing the linear thermal expansion coefficient than Sro. The glass 10 may not contain Bao or may contain Bao. In the glass 10, the content of BaO is preferably 0.1% or more and 15% or less, more preferably 1% or more and 10% or less, and still more preferably 3% or more and 7% or less in terms of mol % on an oxide basis. When the content of BaO falls within this range, it is possible to suppress a decrease in transmittance due to an acid while suppressing deflection with a high Young's modulus.

### Na₂O

The glass 10 may not contain Na₂O or may contain Na₂O. In the glass 10, the content of Na₂O is preferably 0.1% or more and 7% or less, more preferably 1% or more and 5% or less, and still more preferably 2% or more and 3% or less in terms of mol % on an oxide basis. When the content of Na₂O falls within this range, it is possible to suppress a decrease in transmittance due to an acid while suppressing deflection with a high Young's modulus.

### R₂O

R₂O has an effect of increasing the linear thermal expansion coefficient. The glass 10 may not contain R₂O or may contain R₂O. In the glass 10, the content of R₂O is preferably 0.1% or more and 7% or less, more preferably 1% or more and 5% or less, and still more preferably 2% or more and 3% or less in terms of mol % on an oxide basis. When the content of R₂O falls within this range, it is possible to suppress a decrease in transmittance due to an acid while suppressing deflection with a high Young's modulus. The content of R₂O refers to a total value of the contents of the monovalent element oxides contained in the glass 10.

Fe₂O₃

The glass 10 preferably does not contain Fe₂O₃. In the glass 10, the content of Fe₂O₃ on an external ratio is preferably 0.1% or less, more preferably 0.005% or more and 0.07% or less, still more preferably 0.01% or more and 0.05% or less in terms of mass % on an oxide basis. When the content of Fe₂O₃ is as low as described above, it is possible to suppress a decrease in light transmittance. That is, for example, by setting the content of Fe₂O₃ within the above range, the transmittance of the glass 10 having a thickness of 0.7 mm with respect to light having a wavelength of 900 nm can be set to 90% or more, and it is possible to suppress a decrease in the transmittance of infrared light. In addition, Fe₂O₃ is mixed as an impurity in a raw material of a glass. When the content of Fe₂O₃ is too small, a raw material with a small amount of impurities mixed and high quality is required for manufacturing, and the raw material cost required for glass production increases, so that the lower limit thereof is preferably in the above range.

Note that the content of Fe₂O₃ on an external ratio refers to a proportion of the mass of Fe₂O₃ contained in the glass 10 to a total value of the mass of all the components of the glass 10 excluding Fe₂O₃ on an oxide basis.

The glass 10 preferably does not include a sintered body. That is, the glass 10 is preferably glass that is not a sintered body. Here, the sintered body refers to a member in which a plurality of particles are heated at a temperature lower than a melting point to bond the particles to one another. The sintered body includes voids and thus has somewhat high porosity, but the glass 10 is not a sintered body, and thus has low porosity, that is, usually 0%. However, it is allowable to include an inevitable trace amount of pores. The porosity here is a so-called true porosity, and refers to a value obtained by dividing a sum of volumes of pores (voids) communicating with the outside and pores (voids) not communicating with the outside by a total volume (apparent volume). The porosity can be measured in accordance with, for example, JIS R 1634.

In addition, it is preferable that the glass used for the glass 10 be usually amorphous glass, that is, amorphous solid. In addition, this glass may be crystallized glass containing crystals on the surface or inside, but amorphous glass is preferable from the viewpoint of density. Among the ceramics, those prepared by a sintering method are preferably not used because they have low transmittance and high density.

### Shape of Glass

Next, the shape of the glass 10 will be described. As illustrated in FIG. 1, the glass 10 is a plate-like glass substrate including the surface 12A and the surface 12B. The surface 12B may be, for example, parallel to the surface 12A. The glass 10 may have a circular disk shape in plan view, that is, when viewed from a direction orthogonal to the surface 12A, but is not limited to the disk shape and may have any shape, for example, a polygonal plate such as a rectangle. Note that the shape also includes a shape in which cutouts such as a notch or an orientation flat (Orifla) are provided on the outer periphery.

### Thickness of Glass

In addition, a thickness D of the glass 10, that is, a length between the surface 12A and the surface 12B is preferably 0.1 mm or more and 5.0 mm or less, more preferably 0.1 mm or more and 2.0 mm or less, and still more preferably 0.1 mm or more and 0.5 mm or less. By setting the thickness D to 0.1 mm or more, it is possible to suppress the glass 10 from becoming too thin and to suppress breakage due to deflection or impact. By setting the thickness D to 2.0 mm or less, it is possible to suppress weight, and by setting the thickness D to 0.5 mm or less, it is possible to more suitably suppress weight.

### Light Transmittance

The transmittance of the glass 10 having the thickness D of 0.7 mm to light (infrared rays) having a wavelength of 900 nm is preferably 80% or more and 99% or less, more preferably 85% or more and 98% or less, and still more preferably 90% or more and 95% or less. When the transmittance with respect to light having a wavelength of 900 nm falls within this range, infrared rays can be appropriately transmitted.

Also, the internal transmittance of the glass 10 having the thickness D of 0.7 mm with respect to light (ultraviolet ray) having a wavelength of 350 nm is preferably 30% or more and 90% or less, more preferably 35% or more and 86% or less, still more preferably 40% or more and 83% or less, still further preferably 45% or more and 80% or less, still further preferably 50% or more and 77% or less, still further preferably 55% or more and 74% or less, and still further preferably 60% or more and 71% or less. When the transmittance with respect to light having a wavelength of 350 nm falls within this range, ultraviolet rays can be appropriately transmitted.

Note that the transmittance here refers to the light transmittance of the glass 10 in a state before the glass 10 is exposed to an acid. The transmittance can be measured by measuring a spectral transmittance curve with a spectrophotometer or the like.

### Haze Value

The haze value of the glass 10 in a state before the glass 10 is exposed to an acid is preferably 0.001 or more and 0.1 or less, more preferably 0.01 or more and 0.05 or less, and still more preferably 0.02 or more and 0.03 or less. In addition, the haze value of the glass 10 in a state after the glass 10 is exposed to an acid is preferably 0.001 or more and 0.3 or less, more preferably 0.01 or more and 0.2 or less, still more preferably 0.02 or more and 0.15 or less, still further preferably 0.03 or more and 0.1 or less, and still further preferably 0.05 or more and 0.08 or less. As described above, the glass 10 according to the present embodiment has a small amount of decrease in haze value before and after being exposed to an acid, and can suppress a decrease in light transmittance when being exposed to an acid.

The haze value can be measured using a haze meter HZ-2 manufactured by Suga Test Instruments Co., Ltd.

The state before being exposed to an acid refers to, as described above, a state after measuring that the arithmetic average roughness Ra of the surface 12 of the glass 10 is within the above range, and before being exposed to acid. Then, the state after exposure to acid refers to the state after exposure to an acid by measuring that the arithmetic average roughness Ra of the surface 12 of the glass 10 is in the above range. Any condition may be adopted for exposure to an acid, but in this case, the glass 10 is immersed in sulfuric acid (H₂SO₄) having a pH of 2 and a temperature of 40° C. for two hours.

### Linear Thermal Expansion Coefficient

The linear thermal expansion coefficient is a characteristic effective for suppressing deflection, but the degree of the effect greatly depends on the linear thermal expansion coefficient of a semiconductor device to be supported. Since semiconductor devices have various linear thermal expansion coefficients, it is desirable to use glass having a linear thermal expansion coefficient suitable for a semiconductor device to be manufactured as a support substrate. For example, in a process of mounting a semiconductor at a high density, it is assumed that a linear expansion coefficient of a semiconductor device is 5.0 ppm/K. In this case, the linear thermal expansion coefficient of the glass 10 is preferably 6 ppm/° C. or less, more preferably 3 ppm/° C. or more and 5.9 ppm/° C. or less, still more preferably 3.5 ppm/° C. or more and 5.8 ppm/° C. or less, still further preferably 4 ppm/° C. or more and 5.7 ppm/C or less, still further preferably 4.2 ppm/° C. or more and 5.6 ppm/° C. or less, still further preferably 4.4 ppm/° C. or more and 5.5 ppm/° C. or less, still further preferably 4.6 ppm/° C. or more and 5.4 ppm/° C. or less, and still further preferably 4.8 ppm/° C. or more and 5.3 ppm/° C. or less.

The linear thermal expansion coefficient is an average thermal expansion coefficient in a range of 50° C. to 200° C., and is a value measured in accordance with DIN-51045-1 as a standard for thermal expansion measurement. For example, thermal expansion coefficients may be measured in the range of 30° C. to 300° C. using a thermal expansion meter (DIL 402 Expedis Supreme) manufactured by NETZSCH as a measuring device, and an average thermal expansion coefficient in the range of 50° C. to 200° C. among the thermal expansion coefficients may be used as the linear thermal expansion coefficient.

### Method for Manufacturing Glass

The glass 10 may be manufactured by any method, but is manufactured, for example, by the following method. First, a raw material such as silica sand or soda ash, which is a raw material of a compound contained in the glass 10, is heated at a predetermined temperature (for example, 1500° C. to 1600° C.) to be molten. Then, after the molten raw material (glass) is clarified, a forming step of forming the glass into a plate shape is carried out. The formed glass has a composition range of the glass 10 described above on an oxide basis. Then, a slow cooling step is carried out on the glass formed in the forming step to produce the glass 10. In addition, the surface 12 of the manufactured glass 10 may be polished to set the arithmetic average roughness Ra to the above range.

Note that the method for manufacturing the glass 10 is not limited to the above, and any method may be adopted. For example, the slow cooling step is not essential. In addition, various methods can be adopted as the forming step when manufacturing the glass 10, and examples thereof include a melt casting method, a down draw method (for example, an overflow down draw method, a slot down method, and a draw method), a float method, a roll-out method, and a press method.

Next, an example of a manufacturing step in a case where the glass 10 is used for FOWLP manufacturing will be described. In the FOWLP manufacturing, a plurality of semiconductor chips are bonded onto glass 10, and the semiconductor chips are covered with a sealing material to form an element substrate. Then, the glass 10 and the element substrate are separated from each other, and the side of the element substrate opposite to the semiconductor chip is bonded onto, for example, another glass 10. Then, wiring, solder bumps, and the like are formed on the semiconductor chip, and the element substrate and the glass 10 are separated from each other again. Then, the element substrate is cut into pieces for each semiconductor chip, thereby obtaining a semiconductor device.

### Effects

As described above, in the glass 10 according to a first aspect of the present disclosure, the Young's modulus is 90 GPa or more, and an arithmetic average roughness Ra (nm) of the surface 12 defined in JIS B 0601:2001 is equal to or less than the recycling parameter value A.

Since the glass 10 of the present disclosure has the Young's modulus of 90 GPa or more, deflection can be suppressed, and since the arithmetic average roughness Ra of the surface 12 is equal to or less than the recycling parameter value A, a decrease in light transmittance (deterioration in haze value) can be suppressed even after exposure to an acid. Furthermore, a glass having a high Young's modulus tends to have lowered acid resistance, and has a particularly high risk that the surface becomes rough after being exposed to an acid by, for example, acid cleaning, and the light transmittance decreases. On the other hand, in the present disclosure, the arithmetic average roughness Ra of the surface 12 is set to be equal to or less than the recycling parameter value A, which is a threshold based on the composition of the glass 10. This makes it possible to suppress a decrease in light transmittance after exposure to an acid even with a high Young's modulus.

A glass 10 according to a second aspect of the present disclosure is the glass 10 according to the first aspect, and preferably has a Young's modulus of 95 GPa or more. According to the present disclosure, it is possible to suppress a decrease in light transmittance after exposure to an acid while suppressing deflection.

A glass 10 according to a third aspect of the present disclosure is the glass 10 according to the first aspect or the second aspect, and the content of SiO₂ is preferably 35% or more and 60% or less in terms of mol % on an oxide basis. According to the present disclosure, by setting the content of SiO₂ within the above range, it is possible to suppress a decrease in light transmittance after exposure to an acid while suppressing deflection by increasing the Young's modulus.

A glass 10 according to a fourth aspect of the present disclosure is the glass 10 according to the third aspect, and preferably contains: in terms of mol % on an oxide basis,
Al₂O₃: 6% to 30%;
B₂O₃: 0% to 8%;
MgO: 10% to 44%; and
CaO: 0% to 25%.

When the content of each component falls within this range, deflection can be suppressed with the Young's modulus of 90 GPa or more. Note that a numerical range represented by “to” means a numerical range including numerical values before and after “to” as a lower limit value and an upper limit value, and in a case where “to” is used in the following description, the same meaning is applied.

A glass 10 according to a fifth aspect of the present disclosure is the glass 10 according to any one of the first to fourth aspects, and a ratio of the arithmetic average roughness Ra (nm) to the recycling parameter value A is preferably 0.75 or less. This makes it possible to suppress a decrease in light transmittance after exposure to an acid while suppressing deflection.

A glass 10 according to a sixth aspect of the present disclosure is the glass 10 according to any one of the first to fifth aspects, and is preferably used as a substrate. The glass 10 of the present disclosure is suitably used for a substrate.

A glass 10 according to a seventh aspect of the present disclosure is the glass according to the sixth aspect, and is preferably used for manufacturing at least one of a fan out wafer level package or a fan out panel level package. The glass 10 is suitably used for these applications.

### EXAMPLES

Next, examples will be described. Tables 1 to 3 are tables showing the characteristics of the glass of each example. The embodiment may be modified as long as the effects of the invention are obtained.

TABLE 1

| | | Example | Example | Example | Example | Example | Example | Example |
|---|---|---|---|---|---|---|---|---|
| | | 1 | 2 | 3 | 4 | 5 | 6 | 7 |
| (mol %) | SiO₂ | 53 | 50 | 58 | 55 | 60 | 45 | 55 |
| | Al₂O₃ | 12 | 11 | 14 | 12 | 12 | 12 | 9 |
| | B₂O₃ | | | | | | | |
| | MgO | 21 | 15 | 19 | 21 | 21 | 22 | 16 |
| | CaO | 14 | 24 | 7 | 12 | 7 | 21 | 20 |
| | SrO | | | | | | | |
| | BaO | | | | | | | |
| | Na₂O | | | | | | | |
| | TiO₂ | | | 2 | | | | |
| Fe₂O₃ (External ratio wt %) | | | | | | | | |
| Young's modulus (GPa) | | 100 | 100 | 97 | 100 | 97 | 103 | 97 |
| Linear thermal expansion | | 5.1 | 6.0 | 4.0 | 4.8 | 4.2 | 6.0 | 5.4 |
| coefficient (ppm/° C.) | | | | | | | | |
| Recycling parameter A | | 0.445 | 0.415 | 0.558 | 0.492 | 0.569 | 0.305 | 0.490 |
| E | | 1.00 | 0.99 | 0.99 | 0.99 | 0.98 | 1.04 | 0.96 |
| Ra | Before test (nm) | 0.226 | 0.301 | 0.30 | 0.30 | 0.30 | 0.30 | 0.30 |
| | After test (nm) | 0.848 | 0.822 | 0.5< | 0.5< | 0.5< | 0.5< | 0.5< |
| Ra before test/ | | 0.51 | 0.72 | 0.54 | 0.61 | 0.53 | 0.98 | 0.61 |
| Recycling parameter A | | | | | | | | |
| Weight reduction rate (%) | | 0.238 | 0.538 | 0.01< | 0.1< | 0.01< | 0.1< | 0.1< |
| Transmittance (%) @0.7 mmt, | | 85.2 | 76.8 | 80< | 80< | 80< | 75< | 80< |
| 350 nm | | | | | | | | |
| Transmittance (%) @0.7 mmt, | | 93.9 | 92.0 | 90< | 90< | 90< | 90< | 90< |
| 900 nm | | | | | | | | |
| Haze value | Before test | 0.02 | 0.03 | 0.02 | 0.02 | 0.02 | 0.02 | 0.02 |
| | After test | 0.02 | 0.05 | <0.1 | <0.1 | <0.1 | <0.1 | <0.1 |
| Evaluation | Deflection | ⊚ | ⊚ | ⊚ | ⊚ | ⊚ | ⊚ | ⊚ |
| | determination | | | | | | | |
| | Recycle | ◯ | ◯ | ◯ | ◯ | ◯ | ◯ | ◯ |
| | determination | | | | | | | |
| | | Example | Example | Example | Example | Example | Example | Example |
| | | 8 | 9 | 10 | 11 | 12 | 13 | 14 |
| (mol %) | SiO₂ | 55 | 56 | 56 | 56 | 58 | 39 | 46 |
| | Al₂O₃ | 12 | 12 | 12 | 12 | 9 | 29 | 14 |
| | B₂O₃ | 3 | | | 1 | | 6 | 5 |
| | MgO | 19 | 18 | 18 | 19 | 8 | 25 | 34 |
| | CaO | 11 | 11 | 12 | 12 | 25 | | |
| | SrO | | 3 | | 1 | | | |
| | BaO | | | 2 | 1 | | | |
| | Na₂O | | | | | | | |
| | TiO₂ | | | | | | 1 | 2 |
| Fe₂O₃ (External ratio wt %) | | | | | | | | |
| Young's modulus (GPa) | | 96 | 98 | 99 | 97 | 92 | 112 | 107 |
| Linear thermal expansion | | 4.5 | 4.9 | 4.9 | 4.7 | 5.5 | 3.4 | 4.3 |
| coefficient (ppm/° C.) | | | | | | | | |
| Recycling parameter A | | 0.498 | 0.524 | 0.514 | 0.506 | 0.576 | 0.239 | 0.307 |
| E | | 0.96 | 0.98 | 0.97 | 0.96 | 0.92 | 1.10 | 1.04 |
| Ra | Before test (nm) | 0.30 | 0.30 | 0.30 | 0.30 | 0.30 | 0.20 | 0.20 |
| | After test (nm) | 0.5< | 0.5< | 0.5< | 0.5< | 0.5< | 0.4< | 0.4< |
| Ra before test/ | | 0.60 | 0.57 | 0.58 | 0.59 | 0.52 | 0.84 | 0.65 |
| Recycling parameter A | | | | | | | | |
| Weight reduction rate (%) | | 0.1< | 0.1< | 0.1< | 0.1< | 0.1< | 0.1< | 0.1< |
| Transmittance (%) @0.7 mmt, | | 80< | 80< | 80< | 80< | 80< | 70< | 70< |
| 350 nm | | | | | | | | |
| Transmittance (%) @0.7 mmt, | | 90< | 90< | 90< | 90< | 90< | 90< | 90< |
| 900 nm | | | | | | | | |
| Haze value | Before test | 0.02 | 0.02 | 0.02 | 0.02 | 0.02 | 0.02 | 0.02 |
| | After test | <0.1 | <0.1 | <0.1 | <0.1 | <0.1 | <0.1 | <0.1 |
| Evaluation | Deflection | ⊚ | ⊚ | ⊚ | ⊚ | ◯ | ◯ | ⊚ |
| | determination | | | | | | | |
| | Recycle | ◯ | ◯ | ◯ | ◯ | ◯ | ◯ | ◯ |
| | determination | | | | | | | |

TABLE 2

| | | Example | Example | Example | Example | Example | Example | Example | Example |
|---|---|---|---|---|---|---|---|---|---|
| | | 15 | 16 | 17 | 18 | 19 | 20 | 21 | 22 |
| (mol %) | SiO₂ | 53 | 50 | 58 | 55 | 60 | 45 | 55 | 55 |
| | Al₂O₃ | 12 | 11 | 14 | 12 | 12 | 12 | 9 | 12 |
| | B₂O₃ | | | | | | | | 3 |
| | MgO | 21 | 15 | 19 | 21 | 21 | 22 | 16 | 19 |
| | CaO | 14 | 24 | 7 | 12 | 7 | 21 | 20 | 11 |
| | SrO | | | | | | | | |
| | BaO | | | | | | | | |
| | Na₂O | | | | | | | | |
| | TiO₂ | | | 2 | | | | | |
| Fe₂O₃ (External ratio wt %) | | 0.07 | 0.07 | 0.07 | 0.07 | 0.07 | 0.07 | 0.07 | 0.07 |
| Young's modulus (GPa) | | 100 | 100 | 97 | 100 | 97 | 103 | 97 | 96 |
| Linear thermal expansion | | 5.1 | 6.0 | 4.0 | 4.8 | 4.2 | 6.0 | 5.4 | 4.5 |
| coefficient (ppm/° C.) | | | | | | | | | |
| Recycling parameter A | | 0.445 | 0.415 | 0.558 | 0.492 | 0.569 | 0.305 | 0.490 | 0.498 |
| E | | 1.00 | 0.99 | 0.99 | 0.99 | 0.98 | 1.04 | 0.96 | 0.96 |
| Ra | Before test (nm) | 0.226 | 0.301 | 0.30 | 0.30 | 0.30 | 0.30 | 0.30 | 0.30 |
| | After test (nm) | 0.848 | 0.822 | 0.5< | 0.5< | 0.5< | 0.5< | 0.5< | 0.5< |
| Ra before test/ | | 0.51 | 0.72 | 0.54 | 0.61 | 0.53 | 0.98 | 0.61 | 0.60 |
| Recycling parameter A | | | | | | | | | |
| Weight reduction rate (%) | | 0.238 | 0.538 | 0.01< | 0.1< | 0.01< | 0.1< | 0.1< | 0.1< |
| Transmittance (%) @0.7 mmt, | | 70.7 | 63.7 | <75 | <75 | <75 | <70 | <75 | <75 |
| 350 nm | | | | | | | | | |
| Transmittance (%) @0.7 mmt, | | 88.9 | 84.0 | <90 | <90 | <90 | <90 | <90 | <90 |
| 900 nm | | | | | | | | | |
| Haze value | Before test | 0.02 | 0.03 | 0.02 | 0.02 | 0.02 | 0.02 | 0.02 | 0.02 |
| | After test | 0.02 | 0.05 | <0.1 | <0.1 | <0.1 | <0.1 | <0.1 | <0.1 |
| Evaluation | Deflection | ⊚ | ⊚ | ⊚ | ⊚ | ⊚ | ⊚ | ⊚ | ⊚ |
| | determination | | | | | | | | |
| | Recycle | ◯ | ◯ | ◯ | ◯ | ◯ | ◯ | ◯ | ◯ |
| | determination | | | | | | | | |

| | | Example | Example | Example | Example | Example | Example |
|---|---|---|---|---|---|---|---|
| | | 23 | 24 | 25 | 26 | 27 | 28 |
| (mol %) | SiO₂ | 56 | 56 | 56 | 58 | 39 | 46 |
| | Al₂O₃ | 12 | 12 | 12 | 9 | 29 | 14 |
| | B₂O₃ | | | 1 | | 6 | 5 |
| | MgO | 20 | 19 | 19 | 8 | 25 | 34 |
| | CaO | 11 | 12 | 12 | 25 | | |
| | SrO | 3 | | 1 | | | |
| | BaO | | 2 | 1 | | | |
| | Na₂O | | | | | | |
| | TiO₂ | | | | | 1 | 2 |
| Fe₂O₃ (External ratio wt %) | | 0.07 | 0.07 | 0.07 | 0.07 | 0.07 | 0.07 |
| Young's modulus (GPa) | | 97.7 | 98.8 | 97 | 92 | 112 | 107 |
| Linear thermal expansion | | 4.9 | 4.9 | 4.7 | 5.5 | 3.4 | 4.3 |
| coefficient (ppm/° C.) | | | | | | | |
| Recycling parameter A | | 0.513 | 0.505 | 0.506 | 0.576 | 0.239 | 0.307 |
| E | | 0.99 | 0.97 | 0.96 | 0.92 | 1.10 | 1.04 |
| Ra | Before test (nm) | 0.30 | 0.30 | 0.30 | 0.30 | 0.20 | 0.20 |
| | After test (nm) | 0.5< | 0.5< | 0.5< | 0.5< | 0.4< | 0.4< |
| Ra before test/ | | 0.58 | 0.59 | 0.59 | 0.52 | 0.84 | 0.65 |
| Recycling parameter A | | | | | | | |
| Weight reduction rate (%) | | 0.1< | 0.1< | 0.1< | 0.1< | 0.1< | 0.1< |
| Transmittance (%) @0.7 mmt, | | <75 | <75 | <75 | <75 | <65 | <65 |
| 350 nm | | | | | | | |
| Transmittance (%) @0.7 mmt, | | <90 | <90 | <90 | <90 | <90 | <90 |
| 900 nm | | | | | | | |
| Haze value | Before test | 0.02 | 0.02 | 0.02 | 0.02 | 0.02 | 0.02 |
| | After test | <0.1 | <0.1 | <0.1 | <0.1 | <0.1 | <0.1 |
| Evaluation | Deflection | ⊚ | ⊚ | ⊚ | ⊚ | ◯ | ⊚ |
| | determination | | | | | | |
| | Recycle | ◯ | ◯ | ◯ | ◯ | ◯ | ◯ |
| | determination | | | | | | |

TABLE 3

| | | Example | Example | Example | Example | Example | Example | Example | Example |
|---|---|---|---|---|---|---|---|---|---|
| | | 29 | 30 | 31 | 32 | 33 | 34 | 35 | 36 |
| (mol %) | SiO₂ | 53 | 50 | 52 | 66 | 72 | 66 | 72 | 53 |
| | Al₂O₃ | 12 | 11 | 16 | 11 | 6 | 11 | 6 | 12 |
| | B₂O₃ | | | 8 | 8 | | 8 | | |
| | MgO | 21 | 15 | 10 | 5 | | 5 | | 21 |
| | CaO | 14 | 24 | 11 | 5 | 3 | 5 | 3 | 14 |
| | SrO | | | | 5 | 9 | 5 | 9 | |
| | BaO | | | | | 10 | | 10 | |
| | Na₂O | | | 3 | | | | | |
| | TiO₂ | | | | | | | | |
| Fe₂O₃ (External ratio wt %) | | | | | | | | | 0.07 |
| Young's modulus (GPa) | | 100 | 100 | 90 | 76 | 75 | 76 | 75 | 100 |
| Linear thermal expansion | | 5.1 | 6 | 5.1 | 3.6 | 5.8 | 3.6 | 5.8 | 5.1 |
| coefficient (ppm/° C.) | | | | | | | | | |
| Recycling parameter A | | 0.445 | 0.415 | 0.502 | 0.761 | 0.888 | 0.761 | 0.888 | 0.445 |
| E | | 1.00 | 0.99 | 0.92 | 0.82 | 0.73 | 0.82 | 0.73 | 1.00 |
| Ra | Before test (nm) | 0.715 | 0.473 | 0.717 | 0.637 | 0.684 | 0.290 | 0.303 | 0.715 |
| | After test (nm) | 3.147 | 0.642 | 26.600 | 0.878 | 0.934 | 0.249 | 0.303 | 3.147 |
| Ra before test/ | | 1.61 | 1.14 | 1.43 | 0.84 | 0.77 | 0.38 | 0.34 | 1.61 |
| Recycling parameter A | | | | | | | | | |
| Weight reduction rate (%) | | 0.239 | 0.533 | 0.190 | 0.000 | 0.000 | 0.000 | 0.000 | 0.239 |
| Transmittance (%) @0.7 mmt, | | 85.2 | 76.8 | — | 88.5 | 88.5 | 88.5 | 88.5 | 70.7 |
| 350 nm | | | | | | | | | |
| Transmittance (%) @0.7 mmt, | | 93.9 | 92.0 | — | 90.8 | 90.7 | 90.8 | 90.7 | 88.9 |
| 900 nm | | | | | | | | | |
| Haze value | Before test | 0.02 | 0.03 | 0.05 | 0.05 | 0.05 | 0.02 | 0.02 | 0.02 |
| | After test | 0.33 | 0.12 | 20.8 | 0.05 | 0.05 | 0.02 | 0.05 | 0.33 |
| Evaluation | Deflection | ⊚ | ⊚ | ◯ | X | X | X | X | ⊚ |
| | determination | | | | | | | | |
| | Recycle | X | X | X | ◯ | ◯ | ◯ | ◯ | X |
| | determination | | | | | | | | |

| | | Example | Example | Example | Example | Example | Example |
|---|---|---|---|---|---|---|---|
| | | 37 | 38 | 39 | 40 | 41 | 42 |
| (mol %) | SiO₂ | 50 | 52 | 66 | 72 | 66 | 72 |
| | Al₂O₃ | 11 | 16 | 11 | 6 | 11 | 6 |
| | B₂O₃ | | 8 | 8 | | 8 | |
| | MgO | 15 | 10 | 5 | | 5 | |
| | CaO | 24 | 11 | 5 | 3 | 5 | 3 |
| | SrO | | | 5 | 9 | 5 | 9 |
| | BaO | | | | 10 | | 10 |
| | Na₂O | | 3 | | | | |
| | TiO₂ | | | | | | |
| Fe₂O₃ (External ratio wt %) | | 0.07 | 0.07 | 0.07 | 0.07 | 0.07 | 0.07 |
| Young's modulus (GPa) | | 100 | 90 | 76 | 75 | 76 | 75 |
| Linear thermal expansion | | 6 | 5.1 | 3.6 | 5.8 | 3.6 | 5.8 |
| coefficient (ppm/° C.) | | | | | | | |
| Recycling parameter A | | 0.415 | 0.502 | 0.761 | 0.888 | 0.761 | 0.888 |
| E | | 0.99 | 0.92 | 0.82 | 0.73 | 0.82 | 0.73 |
| Ra | Before test (nm) | 0.473 | 0.717 | 0.637 | 0.684 | 0.290 | 0.303 |
| | After test (nm) | 0.642 | 26.600 | 0.878 | 0.934 | 0.249 | 0.303 |
| Ra before test/ | | 1.14 | 1.43 | 0.84 | 0.77 | 0.38 | 0.34 |
| Recycling parameter A | | | | | | | |
| Weight reduction rate (%) | | 0.533 | 0.190 | 0.000 | 0.000 | 0.000 | 0.000 |
| Transmittance (%) @0.7 mmt, | | 63.7 | — | 77.0 | 76.9 | 77.0 | 76.9 |
| 350 nm | | | | | | | |
| Transmittance (%) @0.7 mmt, | | 84.0 | — | 82.8 | 82.6 | 82.8 | 82.6 |
| 900 nm | | | | | | | |
| Haze value | Before test | 0.03 | 0.05 | 0.05 | 0.05 | 0.02 | 0.02 |
| | After test | 0.12 | 20.8 | 0.05 | 0.05 | 0.02 | 0.05 |
| Evaluation | Deflection | ⊚ | ◯ | X | X | X | X |
| | determination | | | | | | |
| | Recycle | X | X | ◯ | ◯ | ◯ | ◯ |
| | determination | | | | | | |

### Example 1

In Example 1, a glass having the composition shown in Table 1 was produced. Incidentally, the content of Fe₂O₃ is expressed in terms of mass % on an external ratio basis as in the above-described embodiment, and the contents of other compositions are expressed in terms of mol % as in the above-described embodiment.

In Example 1, a base plate having a diameter of 320 mm and a thickness of 6 mm was manufactured using a melt casting method. Next, a plurality of plates each having a diameter of 300 mm and a thickness of 3 mm were cut out from the center of the base plate. Both surfaces of these plates were polished using cerium oxide as a polishing material to obtain a glass having a thickness of 0.7 mm.

The Young's modulus was measured for the glass of Example 1. The Young's modulus was measured by an ultrasonic pulse method defined in JIS R 1602:1995. The bulk density of a sample was measured by the Archimedes method, the longitudinal wave velocity and the transverse wave velocity were measured using an ultrasonic thickness gauge 38DL PLUS manufactured by OLYMPUS, and the value of Young's modulus was obtained.

The linear thermal expansion coefficient (ppm/° C.) of the glass of Example 1 was measured. Thermal expansion coefficients were measured in the range of 30° C. to 300° C. using a thermal expansion meter (DIL 402 Expedis Supreme) manufactured by NETZSCH as a measuring device, and an average thermal expansion coefficient in the range of 50° C. to 200° C. among the thermal expansion coefficients was used as the linear thermal expansion coefficient.

For the glass of Example 1, the recycling parameter value A was calculated using the above Formula (1) based on the composition, and the value E was calculated using the above Formula (2).

For the glass of Example 1, the arithmetic average roughness Ra (nm) of the surface in a state before the acid immersion test and the arithmetic average roughness Ra (nm) of the surface in a state after the acid immersion test were measured. As the acid immersion test, the glass was immersed in sulfuric acid (H₂SO₄) having a pH of 2 and a temperature of 40° C. for two hours. The arithmetic average roughness Ra was calculated, for example, from a planar profile obtained by an atomic force microscope.

In addition, a ratio of the arithmetic average roughness Ra (nm) of the surface in the state before the acid immersion test to the recycling parameter value A was calculated.

In addition, a weight reduction rate (%) of the glass of Example 1 before and after the acid immersion test was measured. The weight reduction rate (%) is “100×(Glass weight before acid immersion test-Glass weight after acid immersion test)/(Glass weight before acid immersion test)”.

In addition, for the glass of Example 1, the transmittance with respect to light having a wavelength of 350 nm and the transmittance with respect to light having a wavelength of 900 nm in a state before the acid immersion test were measured. The transmittance was measured by measuring a spectral transmittance curve using an ultraviolet-visible spectrophotometer (UH4150 type, manufactured by Hitachi High-Technologies Corporation).

For the glass of Example 1, the haze value in a state before the acid immersion test and the haze value in a state after the acid immersion test were measured. The haze value was measured using a haze meter HZ-V3 manufactured by Suga Test Instruments Co., Ltd.

The measurement results and the calculation results are shown in Table 1.

### Examples 2 to 42

In Examples 2 to 42, glass was produced in the same manner as in Example 1 except that the composition and the arithmetic average roughness Ra of the glass were set as shown in Tables 1 to 3. The measurement results and calculation results of each example are shown in Tables 1 to 3.

### Evaluation

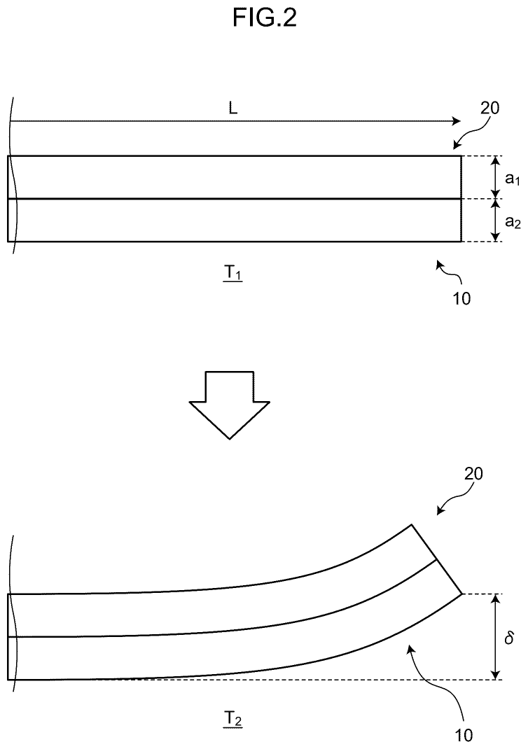

Deflection and recyclability of the glass of each example were determined. The deflection evaluation was carried out on the basis of the Bi-Metal warpage calculation defined in the document S. Timoshenko, “Analysis of Bi-Metal Thermostats” J. Opt. Soc. Am. 11 (1925) 233. FIG. 2 is a schematic view for illustrating a deflection evaluation. Here, as illustrated in FIG. 2, the amount of warpage δ is defined as a displacement amount of an edge portion of the glass 10 in either the upward or downward vertical direction, with the center of the second surface 12B as a height reference when the semiconductor substrate is cooled from a high temperature state of 200° C. to a low temperature of 20° C. in a step of molding and bonding a semiconductor substrate with a resin to the first surface 12A side of the glass 10 processed into the shape of FIG. 1. Specifically, the amount of warpage δ is calculated by the following Equation (3).

$$δ = \frac{6 {L}^{2} ( {α}_{2} - {α}_{1} ) ( {T}_{2} - {T}_{1} ) {( 1 + m )}^{2}}{8 h [ 3 {( 1 + m )}^{2} + ( 1 + mn ) \{ {m}^{2} + {( mn )}^{- 1} \} ]} \qquad ( 3 )$$

Here, as illustrated in FIG. 2, L is a length in a warpage direction (a lateral direction in FIG. 2) of the glass 10, α₁ is a linear thermal expansion coefficient of an element substrate 20, α₂ is a linear thermal expansion coefficient of the glass 10, T₂ is a temperature after cooling (here, 20° C.), and T₁ is a temperature before cooling (here, 200° C.). In addition, m is a₁/a₂, h is a₁+a₂, and n is E₁/E₂. Here, a₁ is the thickness of the element substrate 20, a₂ is the thickness of the glass 10, E₁ is the Young's modulus of the element substrate 20, and E₂ is the Young's modulus of the glass 10. In the deflection evaluation, the element substrate 20 to be bonded to the glass 10 was assumed to have a thickness of 0.3 mm and a Young's modulus of 31.5 GPa in consideration of mounting a semiconductor thereon. The linear thermal expansion coefficient of the element substrate 20 was assumed to be {Linear thermal expansion coefficient of glass (ppm/° C.)}−0.5 ppm/° C. on the assumption that the element substrate is applied to various manufacturing processes, and the amount of warpage & was calculated when the thickness of the glass 10 was 0.7 mm and the length L was 300 mm. In the determination of deflection, the case where an absolute value of each calculated value δ was 0.90 mm or less was evaluated as ∘, the case where the absolute value was 0.86 mm or less was evaluated as ⊚, and the case where the absolute value was higher than 0.90 mm was evaluated as x.

Further, the recyclability means that the light transmittance can be sufficiently secured even after immersion in an acid, and the haze value after the acid immersion test of less than 0.1 was evaluated as ∘, and the haze value after the acid immersion test of 0.1 or more was evaluated as x.

As shown in Tables 1 and 2, in Examples 1 to 28 in which the arithmetic average roughness Ra before the acid immersion test is equal to or less than the recycling parameter value A and the Young's modulus is 90 GPa or more, the deflection determination and the recycle determination are ∘, and it is understood that it is possible to suppress the decrease in light transmittance after exposure to an acid while suppressing the deflection.

On the other hand, Examples 29 to 42 which are comparative examples do not satisfy at least one of the arithmetic average roughness Ra before the acid immersion test being equal to or less than the recycling parameter value A or the Young's modulus being 90 GPa or more, and thus at least one of the deflection determination and the recycle determination is x. Therefore, in the comparative examples, it can be seen that both suppression of deflection and suppression of a decrease in light transmittance after exposure to an acid cannot be achieved.

Although the embodiments of the present invention have been described above, the embodiments are not limited by the contents of the embodiments. In addition, the above-described constituent elements include those that can be easily assumed by those skilled in the art, those that are substantially the same, and those in a so-called equivalent range. Furthermore, the above-described constituent elements can be appropriately combined. Furthermore, various omissions, substitutions, or modifications in the constituent elements can be made without departing from the gist of the above-described embodiments.

According to the present invention, it is possible to suppress a decrease in light transmittance even after exposure to an acid while suppressing deflection.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass, wherein a Young's modulus is 90 GPa or more, and an arithmetic average roughness Ra (nm) of a surface, defined in JIS B 0601:2001 is equal to or less than a recycling parameter value A shown in Formula (1):
$$\begin{matrix}A = ( 13 \times [ {SiO}_{2} ] - 3 \times [ {Al}_{2} {O}_{3} ] - [ {B}_{2} {O}_{3} ] - 7 \times [ MgO ] - 4 \times \\ [ CaO ] - 0.5 \times [ SrO ] - [ BaO ] - [ {R}_{2} O ] ) / 1000\end{matrix} , \qquad ( 1 )$$
where [SiO₂] is a content of SiO₂ in terms of mol % on an oxide basis,
[Al₂O₃] is a content of Al₂O₃ in terms of mol % on an oxide basis,
[B₂O₃] is a content of B₂O₃ in terms of mol % on an oxide basis,
[MgO] is a content of MgO in terms of mol % on an oxide basis,
[Cao] is a content of Cao in terms of mol % on an oxide basis,
[Sro] is a content of Sro in terms of mol % on an oxide basis,
[Bao] is a content of Bao in terms of mol % on an oxide basis, and
[R₂O] is a total value of contents of monovalent element oxides contained in the glass in terms of mol % on an oxide basis.

2. The glass according to claim 1, wherein a Young's modulus is 95 GPa or more.

3. The glass according to claim 1, wherein a content of SiO₂ is 35% or more and 60% or less in terms of mol % on an oxide basis.

4. The glass according to claim 3, comprising:
in terms of mol % on an oxide basis,
Al₂O₃: 6% to 30%;
B₂O₃: 0% to 8%;
MgO: 10% to 44%; and
CaO: 0% to 25%.

5. The glass according to claim 1, wherein a ratio of the arithmetic average roughness Ra (nm) to the recycling parameter value A is 0.75 or less.

6. The glass according to claim 1, which is used as a substrate.

7. The glass according to claim 6, which is used for manufacturing at least one of a fan out wafer level package or a fan out panel level package.
